(19) United States
(12) Patent Application Publication
(10) Pub. No.: US 2008/0109305 A1
(43) Pub. Date: May 8, 2008

(54) Using internet advertising as a test bed for radio advertisements

(75) Inventors: Charles M. Hengel, Woodland, MN (US); Jeff Clement, Maple Grove, MN (US)

Correspondence Address: SCHWEGMAN, LUNDBERG & WOESSNER, P.A., P.O. BOX 2938, MINNEAPOLIS, MN, 55402, US

(73) Assignee: MA Capital LLLP

(21) Appl. No.: 11/800,476

(22) Filed: May 3, 2007

Related U.S. Application Data
(60) Provisional application No. 60/857,618, filed on Nov. 8, 2006.

(51) Int. Cl. G06Q 30/00

(52) U.S. Cl. 705/14

(57) ABSTRACT

This document describes, among other things, systems and methods for using internet advertising as a test bed for radio advertisements. A method comprises accessing an advertisement script at an online system; presenting at least a portion of the advertisement script using an audio recording to a user of the online system to create an advertisement impression; determining an effectiveness of the advertisement impression; and reporting the effectiveness of the advertisement impression.

### CROSS REFERENCE TO RELATED APPLICATIONS

This is a non-provisional patent application related to U.S. Provisional Patent Application Nos. 60/744,325, titled “SYSTEM FOR AND METHOD OF REWARDING SELLERS OR SUPPLIERS OF GOODS OR SERVICES” and 60/857,618 titled “SYSTEM AND METHOD FOR ORGANIZING AND DISTRIBUTING AUDIO INFORMATION”. Further, it is related to United States Non-Provisional Patent Applications Nos. 11/469,719 titled “SYSTEM FOR AND METHOD OF VISUAL REPRESENTATION AND REVIEW OF MEDIA FILES”, 11/469,731 titled “DIRECT RESPONSE SYSTEM FOR AND METHOD OF SELLING PRODUCTS”, 11/469,737 titled “SYSTEM FOR AND METHOD OF STREAMLINING COMMUNICATIONS TO MEDIA STATIONS”, and 11/469,743 titled “ADVERTISING PLACEMENT SYSTEM AND METHOD”, ______ titled “SELLING KEYWORDS IN RADIO BROADCASTS”, ______ titled “BROKERING KEYWORDS IN RADIO BROADCASTS” and, ______ titled “SEARCH RESULTS POSITIONING BASED ON RADIO METRICS” all of which (e.g., both the provisional and non-provisional patent applications) are incorporated by reference in their entirety.

### TECHNICAL FIELD

This patent document pertains generally to advertising, and more particularly, but not by way of limitation, to a system and method for using internet advertising as a test bed for radio advertisements.

### BACKGROUND

Media stations, such as radio stations and television stations, typically devote a portion of broadcast time to advertisements. This advertisement broadcast time is sold to advertisers, frequently through advertising agencies, and the sold broadcast time generates revenue for the media station.

Advertisers use various marketing strategies to test and track advertisements to ensure that less effective advertisements are discontinued in favor of more effective advertising. Because of high production costs, advertisers may be limited to test marketing a small number of advertisements and hoping for the best. A system is needed to address these types of issues.

### BRIEF DESCRIPTION OF THE DRAWINGS

FIG. 1 is a block diagram of an advertisement production system in accordance with an example embodiment.

FIG. 2 is a data flow diagram of an advertisement product system in accordance with an example embodiment.

FIG. 3 is a flow diagram illustrating a method for creating an advertisement in accordance with an example embodiment.

FIG. 4 is a flow diagram illustrating a method for creating an advertisement in accordance with an example embodiment.

FIG. 5 is a flow diagram illustrating a method for creating an advertisement in accordance with an example embodiment.

FIG. 6 is a flow diagram illustrating a method for suggesting a modification to an advertisement in accordance with an example embodiment.

FIG. 7 is a flow diagram illustrating a method for presenting audio track options to a user in accordance with an example embodiment.

FIG. 8 is a graphical user-interface illustrating a script edit screen for creating or editing an advertisement in accordance with an example embodiment.

FIG. 9 is a graphical user-interface illustrating a script edit screen for editing script features in accordance with an example embodiment.

FIG. 10 is a graphical user-interface illustrating a script suggested revisions screen for suggesting revisions to a script in accordance with an example embodiment.

FIG. 11 is a graphical user-interface illustrating a search results screen for providing search results in accordance with an example embodiment.

FIG. 12 is a flow diagram illustrating a method for revising an advertisement in accordance with an example embodiment.

FIG. 13 illustrates a diagrammatic representation of a machine capable of performing the methods or implementing the systems/devices described herein.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

For the purposes of clarity, in some cases, reference is made to a single object (e.g., machine, module, unit, or other component) in the included drawings. However, unless expressly designated, a reference to an object is not to be construed as a being limited to a singular instance of the object, but rather that at least one object may be included in the system, apparatus, process, or computer-readable medium described in the drawings.

Described herein is a system and a method that provides an interface between advertisers and media stations (e.g., radio and television stations). In an embodiment, the interface facilitates a wide-area network-based production model. In a further embodiment, the model allows an advertiser to modify advertisement content at or near real-time. For the purposes of this description, “radio” and “radio transmissions” include terrestrial or satellite audio transmissions.

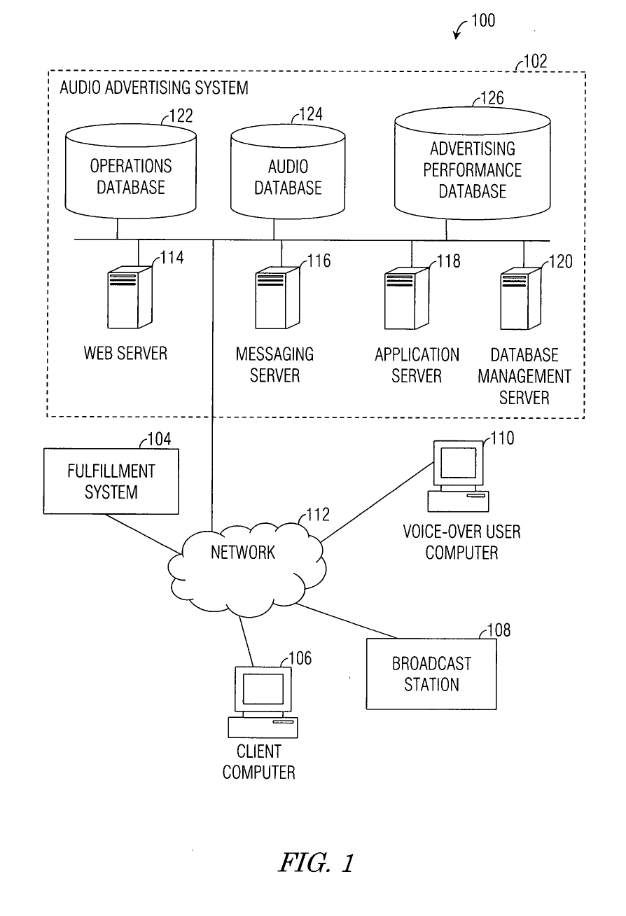

Referring to the figures, FIG. 1 is a block diagram of an advertisement production system 100 in accordance with an example embodiment. The advertisement production system 100 includes an audio advertising system 102, a fulfillment system 104, a client computer 106, a broadcast station 108, and a voice-over user computer 110, all communicatively coupled via a network 112. In an embodiment, the advertisement production system 102 includes a web server 114, a messaging server 116, an application server 118, a database server 120, an operations database 122, an audio database 124, and an advertising performance database 126. In an embodiment, the database server 120 is used to manage at least one of the operations database 122, audio database 124, or advertising performance database 126. The audio advertising system 102 may be implemented as a distributed system, for example one or more elements of the audio advertising system 102 may be located across a wide-area network from other elements of the audio advertising system 102.

The fulfillment system 104 may include businesses, such as call centers, warehouses, distribution centers, production houses, storage facilities, shipping facilities, rebate management, billing facilities, and the like. The fulfillment system 104 can be used to handle customer inquiries, fulfill orders, and handle product returns or other customer issues. In some embodiments, the fulfillment system 104 includes two or more businesses acting in cooperation with each other. For example, a call center, a warehouse, and a shipping company may act together to receive orders, package merchandise, and ship packages to the customer.

The client computer 106 may be used to access the audio advertising system 102 to create, manage, and track advertisements. For example, using a user-interface, such as an internet web browser, a user at the client computer 106 can access the web server 114 in the audio advertising system 102. The client computer 106 may also be used to track inquiries, sales, and other performance data from the fulfillment system 104. The client computer 106 may also be used to track advertising activity at the broadcast station 108, such as when an advertisement was aired, who the active demographic was when the advertisement was aired, and other advertising metrics related to the advertisement's transmission.

The broadcast station 108 may include a radio stations, a television station, a satellite radio station, a high-definition radio station, an internet broadcast station, or other business that broadcasts content over a broadcast medium. The broadcasted content may be distributed over the network 112, for example as a streaming radio broadcast. The broadcasted content may also be broadcasted over terrestrial or satellite networks using radio frequency (RF) transmission.

The voice-over user computer 110 may be used by a voice-over performer (not shown) to access the audio advertising system 102, as described in more detail below. The voice-over computer 110 may include a personal computer, a hand-held computer, a mobile computer, or any other suitable network-capable computing device. The voice-over computer 110 may be a part of a recording studio or recording system.

The network 112 may include local-area networks (LAN), wide-area networks (WAN), wireless networks (e.g., 802.11 or cellular network), the Public Switched Telephone Network (PSTN) network, ad hoc networks, personal area networks (e.g., Bluetooth), virtual private networks (VPN), or other combinations or permutations of network protocols and network types. The network 112 may include a single local area network (LAN) or wide-area network (WAN), or combinations of LAN's or WAN's, such as the Internet. The various devices coupled to the network 112 may be coupled to the network 112 via one or more wired or wireless connections.

Turning now to the components of the audio advertising system 102, the web server 114 may be configured to publish or serve files. The web server 114 may also communicate or interface with the application server 118 to enable web-based presentation information. For example, the application server 118 may consist of scripts, applications, or library files that provide primary or auxiliary functionality to the web server 114 (e.g., multimedia, file transfer, or dynamic interface functions). In addition, the application server 118 may also provide some or the entire interface for the web server 114 to communicate with one or more of the other servers in the audio advertising system 102, e.g., the messaging server 116 or the database management server 120.

The operations database 122 may include data used to administer user accounts, security information (e.g., passwords, personal identification number (PIN)), billing data, or the like. The audio database 124 may include data used to present, store, and track audio tracks and files used in advertising. The advertising performance database 126 may include data used to store, track, and manage advertising metrics, such as how many times an advertisement was broadcasted, over what period of time, to what audience demographic, and what sales resulted from the broadcasted advertising. Other advertising metrics may be stored in the advertising performance database 126, some of which are described below.

The advertising performance database 126 may also include tracking data such as when an advertisement was broadcasted, where the advertisement was broadcasted (e.g., radio station, geographic region), advertising response statistics, or other performance metrics related to an advertisement or an advertising campaign.

Databases in the audio advertising system 102, including the operations database 122, the audio database 124, and the advertising performance database 126, may be implemented as a relational database, a centralized database, a distributed database, an object oriented database, or a flat database in various embodiments.

During operation, in an embodiment, a user can use the client computer 106 to connect with the audio advertising system 102 via the network 112. Using a user-interface provided by the audio advertising system 102, such as via the web server 114, the user can construct an advertisement. In an embodiment, the user can provide a script to the audio advertising system 102. The script may be stored in the operations database 122 for later reference. The audio advertising system 102 may access the audio database to present pre-recorded voice samples or other audio samples to the user. In addition, the audio advertising system 102 may provide information describing available live performers (e.g., voice-over performers). The user can then select a voice sample, audio sample, or live performer that is suitable and generate an audio advertisement. If the user chooses a live performer, then an order request can be generated and communicated to a voice-over user at the voice-over user computer. The live performer can record their rendition of the script and transmit it to the audio advertising system 102, which may store it in the audio database 124. In some embodiments, the user may select more than one voice samples, audio samples, or live performers to use in combination. The user can then test the audio advertisement and make adjustments using the user-interface provided by the web server 114. The test can be performed in an online medium. This may be advantageous to reduce costs or to increase exposure. Online test results can be stored in the advertising performance database 126. Periodically, the user can revise the advertisement and continue testing in the online environment. Once the user is satisfied with the quality of the advertisement, the user can publish it to a broadcast station 108. In another example embodiment, the audio advertising system 102 may automatically determine that the advertisement is of sufficient quality and transmit the advertisement to the broadcast station 108 for use in a commercial context.

The broadcast station 108 may broadcast the advertisement on a periodic or recurring schedule. The advertisement may contain a way to contact the advertiser, such as a web site address, a telephone number, or other means. A listener who is interested in the advertised material can contact the fulfillment system 104 to obtain more information about a product or service, place an order, or manage an existing order. The broadcast station 108 and the fulfillment system 104 can transfer advertising data to the audio advertising system 102, which may store the data in the advertising performance database 126 for analysis. Advertising data may include data such as the advertisement broadcasted, the time of the broadcast, the broadcast station that broadcasted the advertisement, the demographic of the broadcast station, the number of contacts, the contact method used, the result of the contact (e.g., inquiry or order), the cost of the advertisement, and the like. Using this data, the audio advertising system 102 can analyze and compile advertising performance metrics, such as advertisement cost per order. The advertising performance metrics may be presented to the user at the client computer 106, who may then revise the advertisement or construct new advertisements.

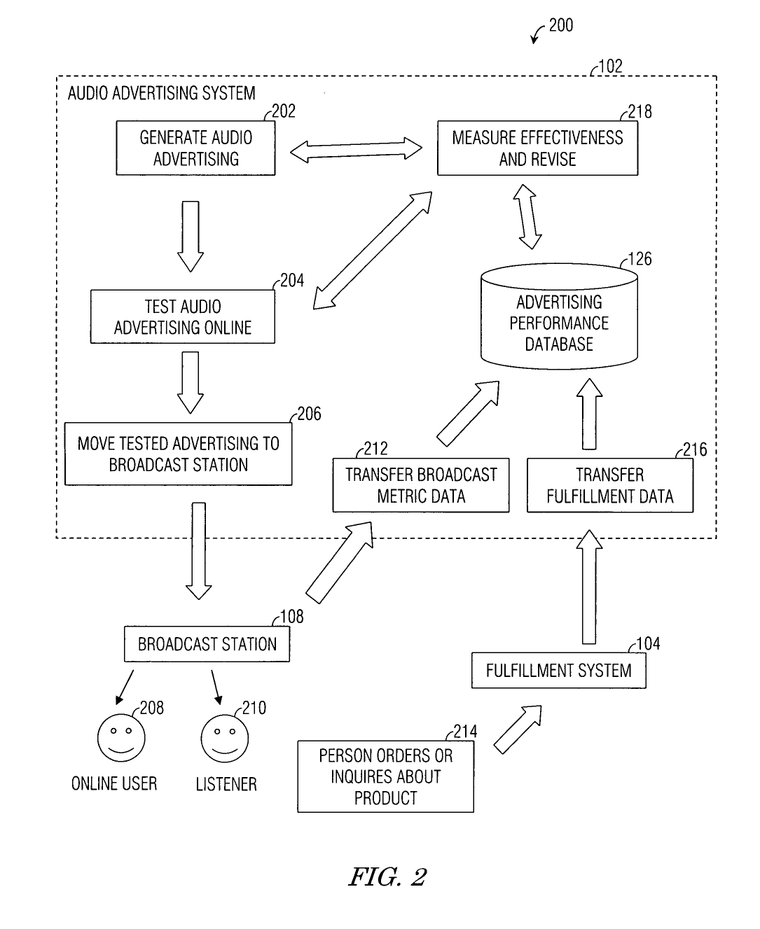

FIG. 2 is a data flow diagram 200 of an advertisement product system in accordance with an example embodiment. At 202, an audio advertisement is generated. In an embodiment, a user can access the audio advertising system 102 to generate an audio advertisement. At 204, the audio advertisement is tested online. For example, the audio advertisement may be presented to online users via a network, such as network 112, using technologies such as webcasting using streaming audio. In other examples, an audio file may be presented using a plug-in player, such as WINDOWS MEDIA PLAYER as provided by MICROSOFT, Inc. or QUICKTIME as provided by APPLE, Inc. The audio file may be formatted using industry-standard formats, such as MPEG-1 (Moving Picture Experts Group) Audio Layer 3 (*.mp3), Waveform Audio Format (*.wav), Advanced Audio Coding (AAC) (MPEG-4 Part 3), or Windows Media Audio (*.wma), as well as other digital media formats. The effectiveness of the online testing can be measured, tracked, and stored (block 218). If the effectiveness of the online test is below a threshold value (e.g., based on response rate, click through traffic, or resulting orders or inquiries), then the advertisement may be revised manually or automatically. The revised advertisement can then be tested again in the online medium.

At 206, after testing, the advertisement is moved to the broadcast station 108. The broadcast station 108 can then broadcast the advertisement to an online user 208 or a listener 210. The online user 208 and listener 210 are examples of people that may receive the broadcasted advertisement. Typically, a listener 210 is a person who is receiving an audio broadcast over a radio frequency transmission, such as radio broadcasting, while an online user 208 is a person who is receiving an audio broadcast over a network, such as the Internet.

At 212, the broadcast station can transfer broadcast metric data to the advertising performance database 126 associated with the audio advertising system 102. Broadcast metric data may include data such as play times, estimated audience size or demographic, cost of airtime, and the like.

At 214, after hearing the broadcasted advertisement, the online user 208 or the listener 210 may wish to inquire or order the product or service advertised. In an embodiment, the online user 208 or listener 210 may contact the fulfillment system 104, for example, by using a toll-free phone number provided in the advertisement. The fulfillment system 104 can then obtain the order information and arrange for the advertised service to be rendered or the advertised product to be shipped.

At 216, information related to inquiries or orders is communicated to the advertising performance database 126. By correlating the broadcast times or geographies with fulfillment system information, the advertiser can gain a better understanding of the effectiveness of the advertisement.

At 218, the effectiveness of an advertisement can be measured during various times during the process. Depending on the result of the measurement, the advertisement may be revised. For example, after receiving fulfillment system data, an advertiser may revise or replace an advertisement at the process block 202. As another example, during online testing, at process block 204, an advertiser may revise or replace an advertisement based on test results.

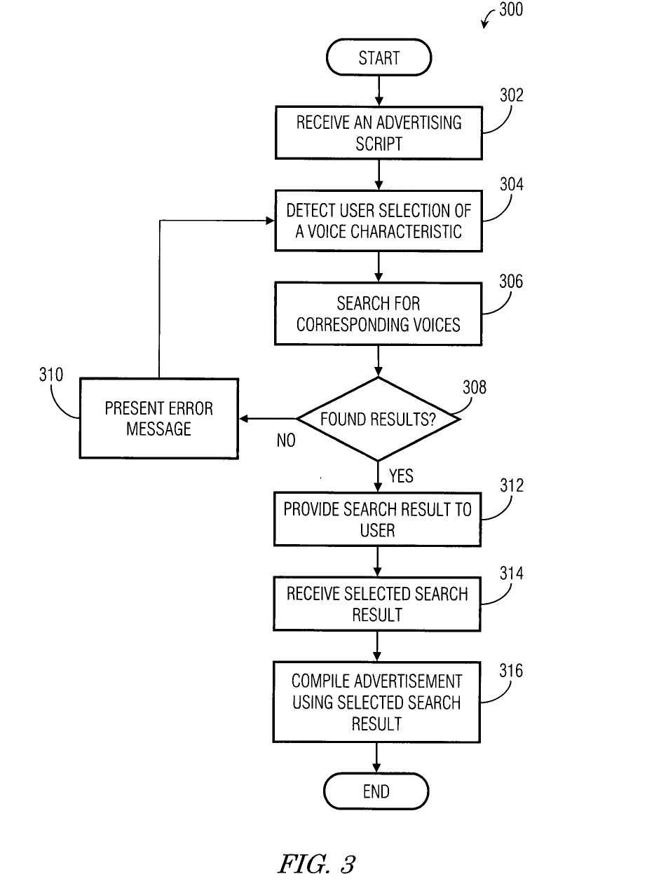

FIG. 3 is a flow diagram illustrating a method 300 for creating an advertisement in accordance with an example embodiment. At 302, an advertising script is received. The advertising script may be formatted in a standardized interface language, such as Extensible Markup Language (XML), or as a plain text file, in various embodiments. The advertising script may be submitting using an internet-enabled user-interface, such as a web browser HTML form.

After receipt of the script, at 304, one or more user selections are detected, where the user selections indicate corresponding voice characteristics. In an embodiment, a user-interface can be presented to a user via a web browser and the user can select one or more options that represent voice characteristics. In various embodiments, the voice characteristics may include aspects such as the gender, age, language, accent, style, identity, or notoriety of the speaker.

At 306, audio tracks are searched to find close or exact matches of voices that correlate to the selected voice characteristics. In an embodiment, the audio tracks are stored in the audio database 124. In further embodiments, the audio tracks may include a voice sample, a synthesized voice sample, or a recorded voice track.

At the decision block 308, if results are found, then at 312, the results are presented to a user. If, however, there are no results that match or are closely correlated, then at 310, an error message is presented. In various embodiments, the error message may include a suggestion of how to improve or modify a query such that the query will result in at least one search result.

At 314, a selected search result is received. The selected search result may include one or more voice tracks, in an embodiment. At 316, the script is used in combination with the selected voice track to compile an advertisement.

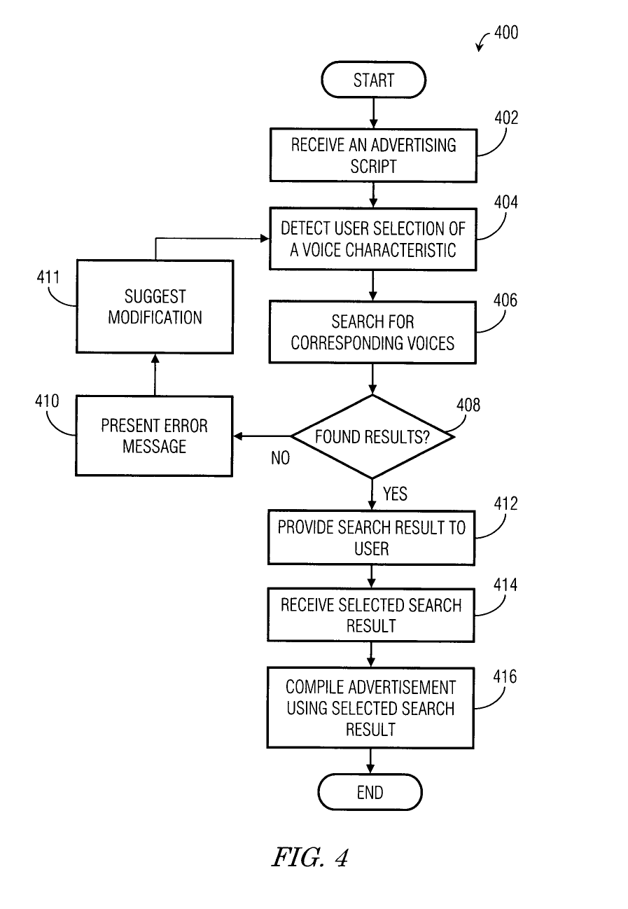

FIG. 4 is a flow diagram illustrating a method 400 for creating an advertisement in accordance with an example embodiment. The method described in FIG. 4 is similar to the method shown in FIG. 3, except that in the event that no search results are found, at 411, a modification of one or more search parameters is suggested to the user. For example, if the initial search parameters (voice characteristics) were “male,” “Brooklyn accent,” and “youthful,” which when used did not result in any matching voice tracks, then a suggested modified search may include “male” and “youthful,” which would provide search results. Various methods may be employed to suggest alternative queries to a user that may result in a non-empty search result set, such as ranking search terms by their popularity, ranking search terms by the number of hits, grouping search terms in combinations that provide a threshold number of results, and the like. In an embodiment, the analysis and suggested modification is performed using a neural network. In general, a neural network is capable of using heuristic programming or fuzzy logic to approximate a learning system. In another embodiment, discrete analysis is used to determine a modified search.

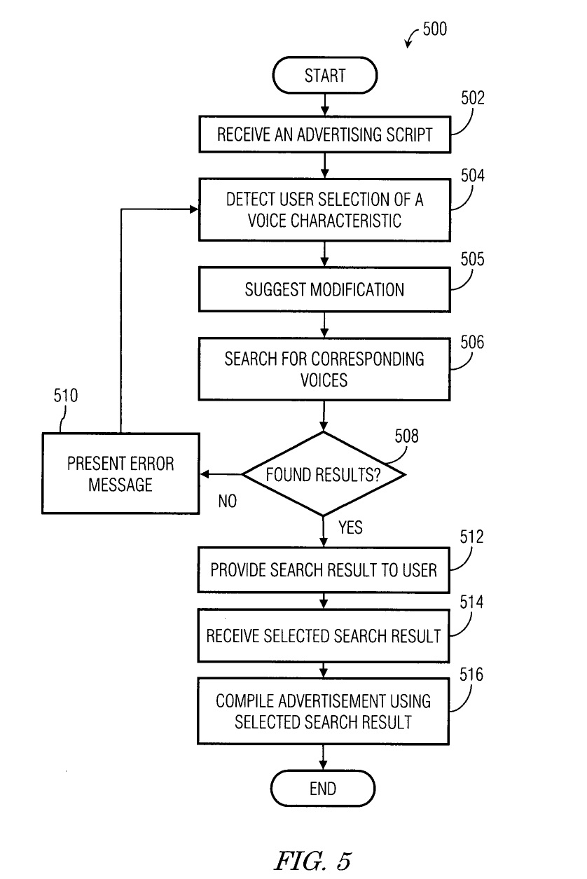

FIG. 5 is a flow diagram illustrating a method 500 for creating an advertisement in accordance with an example embodiment. The method described in FIG. 5 is similar to the method shown in FIG. 3, except that after the script is provided (block 502) and one or more user selections are detected (block 504) the method 500 may suggest modifications (block 505). The method 500 may suggest modification to the script's copy, voice characteristics selected by the user, or other advertisement information. In an embodiment, using advertising performance database 126, the method may determine a correlation between a particular voice characteristic and advertising performance. The advertising performance may be an estimate based on past result or past performance of the same or similar advertisements. For example, if a user selects “male,” “British accent,” and “mature voice,” as voice characteristics, the method 500 may determine that using a mature British voice is generally less successful than using a youthful British voice. The method 500 may provide such information to the user and suggest a modification or revision of the selected voice characteristics. As another example, an advertisement for a weight loss treatment may include the phrase “lose weight.” Using past performance of similar advertising, the method 500 may determine that the use of the phrase “get fit” has been observed to be more effective than using the phrase “lose weight.” Using this information, the method 500 may provide a suggested revision to the script's copy along with statistics to allow the user to make an informed decision whether to revise the script. Similar to the method in FIG. 4, in some embodiments, block 505 may be implemented using a neural network, discrete analysis, or other analysis technique.

In some embodiments, the suggested modification or revision blocks of FIG. 4 (block 411) and FIG. 5 (block 505) may be used in combination to provide a user more guidance and input during the advertisement creation or revision process.

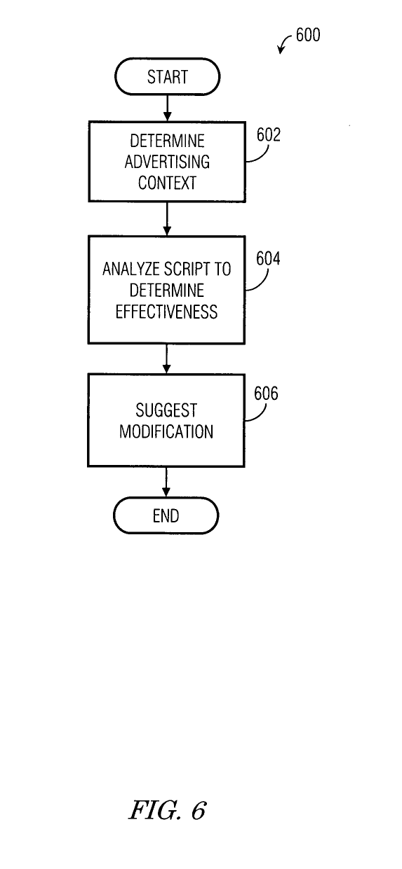

FIG. 6 is a flow diagram illustrating a method 600 for suggesting a modification to an advertisement in accordance with an example embodiment. The suggested modification may include a change in advertising copy (e.g., words or phrases) or a change in selected voice characteristics. In various embodiments, the method 600 may be used at block 411 in FIG. 4 or block 505 in FIG. 5, or at both steps.

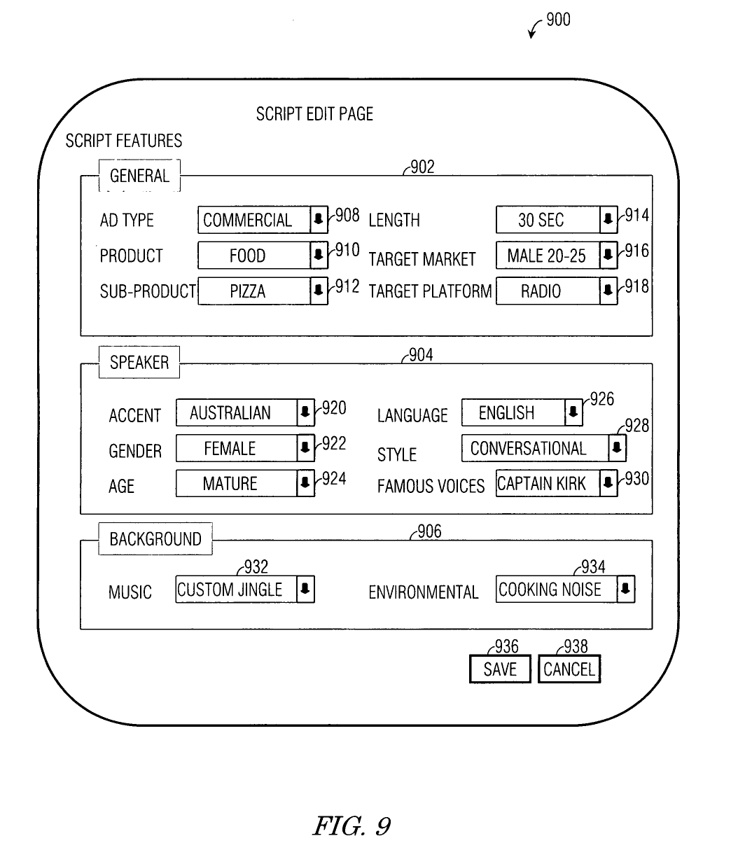

At 602, an advertising context is determined. The advertising context may be formed by one or more advertising characteristics, such as the type of advertisement, the target market, the product being advertised, the length of the advertisement, and the like. The advertising context may be obtained, at least in part, by analyzing the advertisement script. For example, the advertisement script may be searched for one or more key words that identify a product or service being sold or advertised, a target market, an advertisement genre, or other advertising characteristics. The advertisement context may also be obtained, at least in part, by analyzing an advertisement profile. An advertisement profile may be one or more parameters that describe the advertisement script. The one or more parameters may be input by a user using a user-interface, such as one described with reference to FIG. 9.

At 604, the advertisement script is analyzed. The analysis may be performed using a neural network, discrete analysis, or other analytical techniques, in various embodiments. In an embodiment, the analysis includes deconstructing the advertisement script into a plurality of words, determining an estimated efficacy of each word in the plurality of words, and replacing a word when the estimated efficacy is below a threshold value. For example, each word in a script can be classified into a grammatical category, such as noun, verb, adjective, adverb, object or the like. Some common words or connecting words, such as the conjunctions “and” and “or” may be ignored by the analysis. Words may then be ranked or otherwise sorted by effectiveness based on a corresponding advertising context. Words may also be sorted and grouped by grammatical categories, which may then be ranked or otherwise sorted by effectiveness based on a corresponding advertising context. In an embodiment, for each word, a database can be searched for a corresponding word and the estimated efficacy of the word being analyzed and the corresponding word found can be compared using an advertisement context based on an advertisement feature. In an embodiment, the advertisement feature may include an advertisement type, a product, a sub-product, an advertisement length, a target market, and a target platform. Thus, the estimated efficacy of a word may be dependent on the advertising context or advertising feature. For example, a word's efficacy may differ when viewed in the context of an advertisement of a particular product versus an advertisement for a particular target market.

In another embodiment, the analysis (block 604) includes deconstructing the advertisement script into a plurality of phrases, wherein each phrase includes at least one word, determining an estimated efficacy of each phrase in the plurality of phrases, and replacing a phrase when the estimated efficacy is below a threshold value. Phrase analysis may be more effective in some situations where individual words are too generic to analyze. For example, the phrase “I wanna be like Mike” is a powerful catch phrase from GATORADE commercials featuring Michael Jordan, but each word individually may lack marketing substance. Determining the estimated efficacy of each phrase may include for each phrase, searching a database for a corresponding phrase, and comparing the estimated efficacy of each phrase to an estimated efficacy of the corresponding phrase, using a advertisement context based on an advertisement feature, wherein the advertisement feature is selected from the group of advertisement features consisting of an advertisement type, a product, a sub-product, an advertisement length, a target market, and a target platform, in embodiments.

Advertisement types can include modes, such as radio, television, or internet; production styles such as film, commercial, animated, or documentary; or themes such as parody, comedic, political, satirical, informational, or storyline, in various embodiments. The advertisement length may be dependent on the mode of the advertising, for example, a television advertisement may be standard thirty seconds, while an internet advertisement may be shorter or longer, depending on the context. An advertising market may be defined using a target demographic. A target platform can include the intended broadcast medium for the advertisement, such as radio, television, webcast, etc.

The threshold value used to determine whether a word or phrase is preferable may be set by a user (e.g., an administrator or advertiser) or automatically by the system 102. The threshold value may be a function of advertisement response (e.g., number of orders per thousand impressions), advertisement usage (e.g., the reliability of corresponding performance data may be dependent on the number of times an advertisement is broadcast), or other advertising statistics.

In embodiment, revisions may be based on analysis that includes comparing the advertisement script to a corpus of previously used scripts. For example, the corpus of scripts may include scripts of a similar genre, scripts from the same or similar advertiser, or scripts for the same or similar product. Other similarities may be used to determine a relevant corpus of scripts. The corpus of previously used scripts may be stored in the advertising performance database 126, along with advertising performance metrics. Using the advertising performance metrics, the method 600 may provide a revision of the advertisement script.

At 606, using the advertising context determined at block 602, one or more revisions may be determined and provided to the user. The revisions may include modifications or additions to the script's text, organization, or theme, in various embodiments. The revisions may further include modifications or additions to selected voice characteristics, in embodiments. The revisions can be based on the characteristics identified in an effort to maximize the efficacy of an advertisement for the particular advertising context.

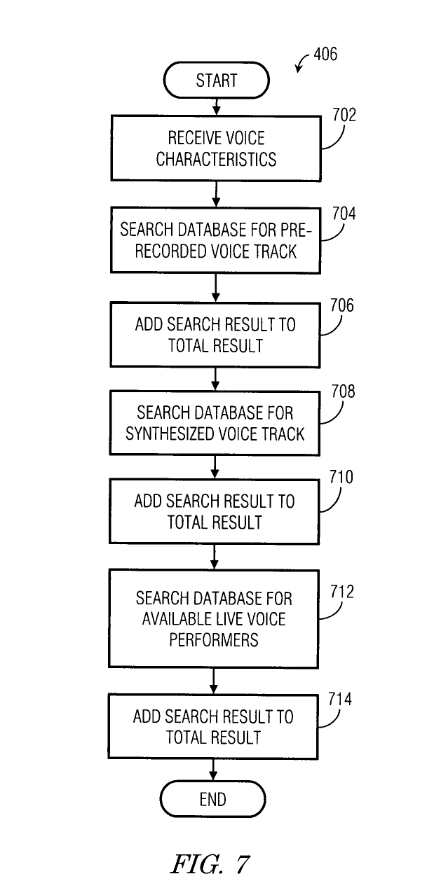

FIG. 7 is a flow diagram illustrating a method 406 for presenting audio track options to a user in accordance with an example embodiment. At 702, one or more voice characteristics are received. In an embodiment, the voice characteristics are those selected by a user, such as in step 404 in FIG. 4. Voice characteristics may include the accent, gender, age, language, style, or identity of a speaker. Voice characteristics may further include whether the voice is a recorded human voice or a synthesized voice.

At 704, a database is searched for pre-recorded voice tracks. Pre-recorded voice tracks may include words or phrases that, when concatenated, can form a full audio version of an advertising script. Pre-recorded voice tracks may also include individual syllables to combine, concatenate, or arrange to create an audio version of the advertising script. In an embodiment, pre-recorded voice tracks are associated with one or more voice characteristics in the database, such that when searching for a particular voice characteristic, the associated voice track can be identified and retrieved.

At 706, those voice tracks that match or correspond with the provided voice characteristics are added to a search result. The search result may be sorted, grouped, or otherwise arranged into rankings, classifications, or categories, to provide conceptual or visual organization to a user when the search result is presented.

At 708, a database is searched for synthesized voice tracks. Synthesized voice tracks may include computer-generated voice samples or acoustically-modified, recorded human voices. Similar to the pre-recorded voice tracks, the synthesized voice tracks may be associated with one or more voice characteristics to enable searching, sorting, and organizing. At 710, those synthesized voice tracks that match or correspond with the provided voice characteristics are added to the search result.

At 712, a database is searched for live performers that have voice characteristics similar to those specified. Live performers are typically voice-over artists that can professionally read an advertisement script for a broadcast medium. In some cases, live performers may include famous or notorious people that are willing to provide a voice-over track for compensation or charity. At 714, those live performers that match or correspond with the provided voice characteristics are added to the search result.

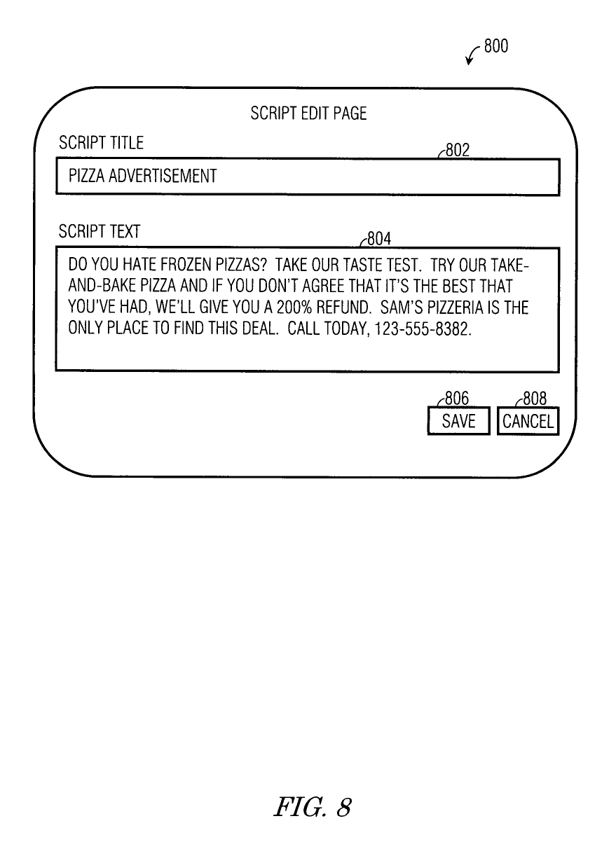

FIG. 8 is a graphical user-interface illustrating a script edit screen 800 for creating or editing an advertisement in accordance with an example embodiment. The script edit screen 800 includes a script title control 802 and a script text control 804. A user can input a script title using the script title control 802 to later identify and recognize the script. The script title control 802 may be programmatically controlled to constrain an attribute of the script title control 802, such as the length or content. For example, a maximum length of eighty characters may be imposed on the script title. As another example, certain characters, such as special characters like “!,” “@,” or “̂” may be prohibited in a script title.

The script text control 804 may be similarly controlled to constrain the content, length, or other attribute. After a user inputs a script title and text, activating the save control 806 can save the inputted content. If the user decides to discard the content, for example, when making changes to the script and then deciding later to abandon those changes, the user can activate the cancel control 808 to exit the script edit screen 800.

FIG. 9 is a graphical user-interface illustrating a script edit screen 900 for editing script features in accordance with an example embodiment. The script edit screen 900 may include one or more script features, organized into a general portion 902, a speaker portion 904, and a background portion 906. The general portion 902 may include general features associated with a script. For example, the advertisement type 908, the product being advertised 910, the sub-product 912, the length of the advertisement 914, the target market 916, and the target platform 918. In the example shown, these various controls are provided as drop down lists. In other examples, the input controls may include other forms, such as radio buttons, check boxes, text fields, and the like.

The speaker portion 904 of the script edit screen 900 may include attributes of a speaker or a recorded voice. For example, the attributes or characteristics may include an accent 920, a gender 922, an age, 924, a language 926, a style 928, or an identity 930. In some embodiments, when an identity is selected using the identity control 930, the other controls are disabled or ignored. In other embodiments, controls specifying a particular voice attribute may be combined with a personality voice to create a derivative voice. For example, if a user selected “Captain Kirk” as a famous voice using the identity control 930 and an accent of “Scottish” using the accent control 920, the system may provide a derivative voice using the combination of the two.

The background portion 906 includes controls to designate background noises or music. For example, the background portion 906 may include a music control 932 and an environmental control 934. The music control 932 can be used to select a jingle, music theme, or other sound track to be played in the background during a script's narration. The environmental control 934 can be used to designate a different type of background noise. Examples of environmental noises include cooking sounds, car traffic, airplane engines, discussions or talking, running water, wind, or the like.

After a user inputs script features, activating the save control 936 can save the features. If the user decides to discard changes, the user can activate the cancel control 938 to exit the script edit screen 900.

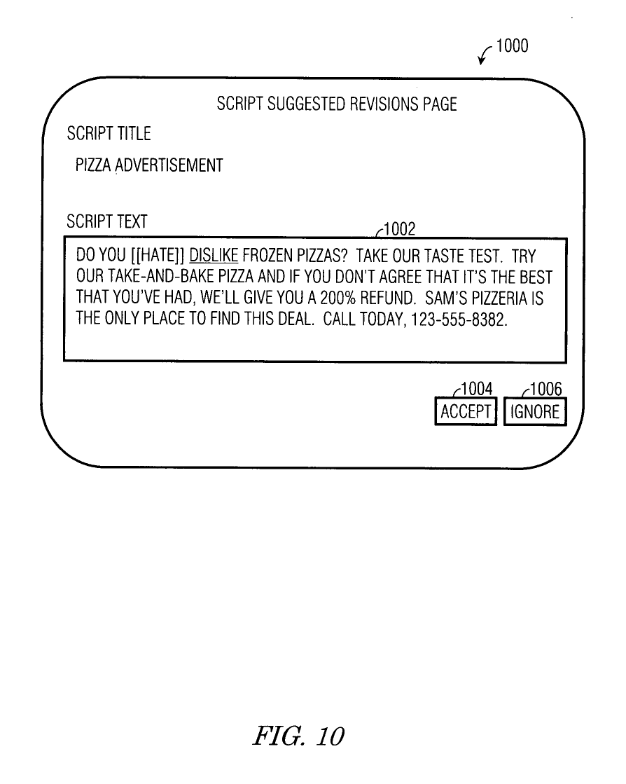

FIG. 10 is a graphical user-interface illustrating a script suggested revisions screen 1000 for suggesting revisions to a script in accordance with an example embodiment. The script suggested revisions screen 1000 may include a script text control 1002 to present a marked up version of the script text to a user. In the example shown, a suggested revision of replacing the word “hate” with the word “dislike” is presented in the script text control 1002. The suggested revision may be based on analysis, such as that described above with relation to FIG. 6. The user may make further revisions to the text using the script text control 1002 and accept the changes using the accept control 1004 or reject the suggested revisions using the ignore control 1006.

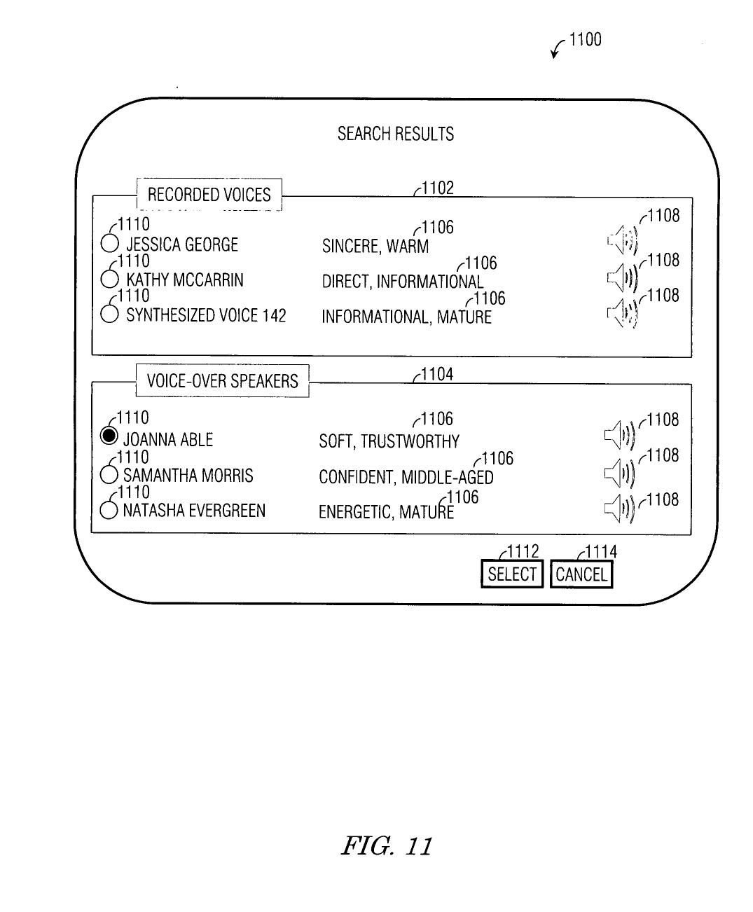

FIG. 11 is a graphical user-interface illustrating a search results screen 1100 for providing search results in accordance with an example embodiment. The search results screen 1100 may include a recorded voices portion 1102 and a voice-over speakers portion 1104. The recorded voices portion 1102 may include pre-recorded human voices and synthesized voices. The voice-over speakers portion 1104 may include names or identities of voice-over performers that match or correspond with provided voice characteristics. Each voice sample, voice track, or identified voice-over performer may include a brief description 1106 of the voice sample or speaker and a playback control 1108 to listen to a sample of the voice sample or speaker. Also, each voice sample can include a selection control 1110 to select a particular voice sample. In the example shown, the selection control 1110 is a radio button, which restricts the user to choosing a single selection. In other examples, a checkbox control may be used as the selection control 1110, which can allow a user to choose two or more voice samples. The system may use the selected voice sample in a duet-like narration or other combination.

The user may indicate the selected voice sample using the select control 1112 or cancel the search using the cancel control 1114. Activating the select control 1112 can submit the selected voice sample or voice samples to be used in the advertisement.

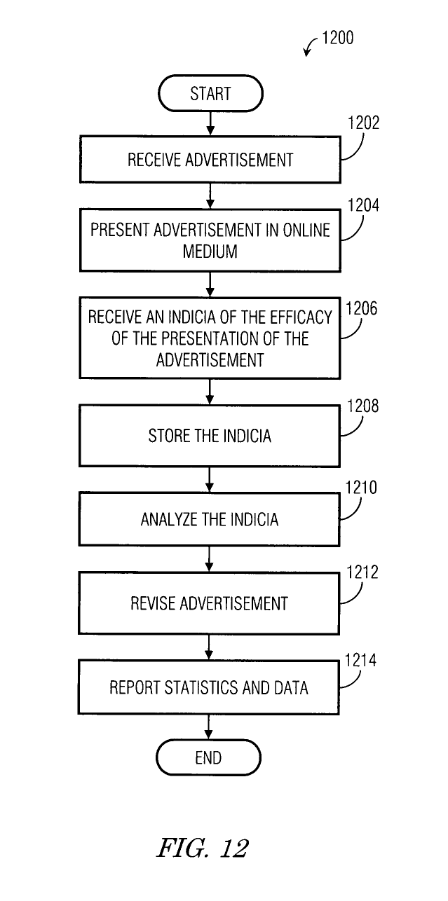

FIG. 12 is a flow diagram illustrating a method 1200 for revising an advertisement in accordance with an example embodiment. At 1202, an advertisement is received. The advertisement may be the result of a process, such as that described in FIGS. 4-6. At 1204, the advertisement is presented in an online medium, such as in a webcast over the Internet. Other examples of online media include an audio file served in a web page, an audio advertisement played over a cellular phone, or an audio advertisement delivered over satellite or high-definition radio. An indicia of effectiveness is received at block 1206. The indicia may be the number of sales that are a result of the advertisement. The indicia may include other data, such as the number of inquiries of an advertised product or service, a number of web page hits, a number of phone calls received, a number of promotional coupons redeemed, or the like. Other indicia may include professional product reviews, editor comments or reviews, consumer reviews, news stories or other articles that mention, describe, praise, or criticize the advertised product or service, or other press. In an embodiment, if the effectiveness of an advertisement is over a threshold value, the advertisement can be delivered to a broadcast station for commercial use.

The indicia of effectiveness is stored (block 1208) and analyzed (block 1210). The indicia may be stored in the advertising performance database 126, in an embodiment. The indicia may be compared to one or more threshold values, such as a predicted number of sales, to determine whether, or to what extent, the advertisement campaign can be considered successful. In an embodiment, the analysis includes parsing the text-based advertisement script to determine a characteristic, such as a type of advertisement, a type of content, a target market, an advertisement structure, and a target advertising platform. Using the characteristic, the method 1200 can determine a revision that may make the advertisement more effective.

At 1212, the advertisement is revised. In an embodiment, the advertisement script is automatically revised by the method 1200. In an embodiment, the revised advertisement script is presented to a user for approval before a revised advertisement is generated. The revised advertisement script may be presented in a user-interface, such as the one illustrated in FIG. 10. In an embodiment, an audio characteristic associated with the advertisement is revised by the method 1200. Audio characteristics may include features such as those described in FIG. 9. For example, if the unmodified advertisement used a mature female voice, the method 1200 may determine that a youthful male voice may be more effective and suggest the revised features. Determining what revisions may be appropriate to increase the effectiveness of the advertisement can be performed by a neural network, in an embodiment. For example, a neural network may analyze the data stored in the advertising performance database 126 and determine that for a particular type of advertisement broadcast over a particular type of medium, a textual or audio modification may produce better advertising results.

At 1214, statistics and data can be reported to the user. For example, sales data, impression data, and other performance data can be collected and presented. The user may desire to make other modifications to the advertisement using the presented data.

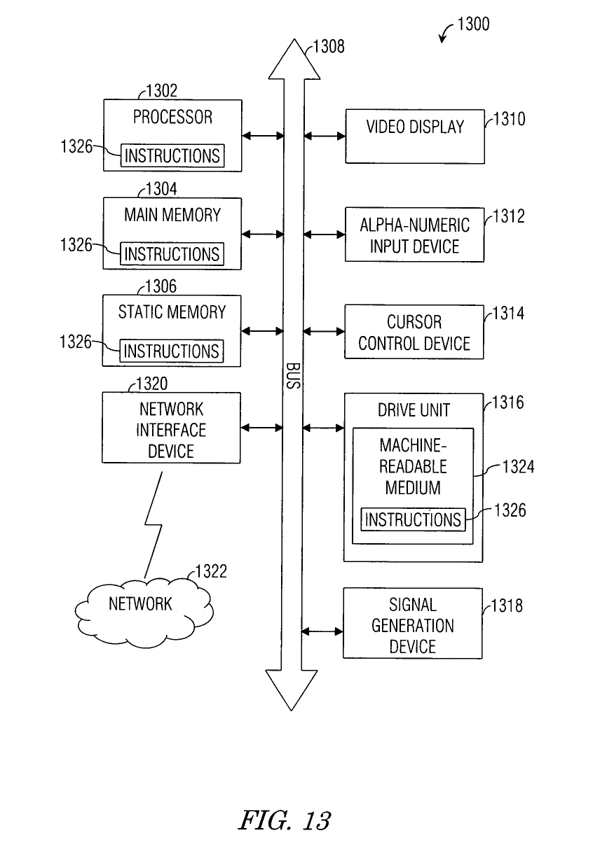

FIG. 13 illustrates a diagrammatic representation of a machine 1300 capable of performing the methods or implementing the systems/devices described herein. In alternative embodiments, the machine may comprise a computer, a network router, a network switch, a network bridge, a Personal Digital Assistant (PDA), a cellular telephone, a web appliance, a set-top box (STB) or any machine capable of executing a sequence of instructions that specify actions to be taken by that machine.

The machine 1300 includes a processor 1302, a main memory 1304, and a static memory 1306, which communicate with each other via a bus 1308. The machine 1300 may further include a video display unit 1310 (e.g., a liquid crystal display (LCD) or a cathode ray tube (CRT)). The machine 1300 also includes an alphanumeric input device 1312 (e.g., a keyboard), a cursor control device 1314 (e.g., a mouse), a disk drive unit 1316, a signal generation device 1318 (e.g., a speaker) and a network interface device 1320 to interface the computer system to a network 1322.

The disk drive unit 1316 includes a machine-readable medium 1324 on which is stored a set of instructions or software 1326 embodying any one, or all, of the methodologies described herein. The software 1326 is also shown to reside, completely or at least partially, within the main memory 1304 and/or within the processor 1302. The software 1326 may further be transmitted or received via the network interface device 1320.

For the purposes of this specification, the term “machine-readable medium” or “computer-readable medium” shall be taken to include any medium which is capable of storing or encoding a sequence of instructions for execution by the machine and that cause the machine to perform any one of the methodologies of the inventive subject matter. The term “machine-readable medium” or “computer-readable medium” shall accordingly be taken to include, but not be limited to, solid-state memories, optical and magnetic disks, and carrier wave signals. Further, while the software is shown in FIG. 13 to reside within a single device, it will be appreciated that the software could be distributed across multiple machines or storage media, which may include the machine-readable medium.

Method embodiments described herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAM's), read only memories (ROM's), and the like.

Although specific embodiments have been illustrated and described herein, it will be appreciated by those of ordinary skill in the art that any arrangement that achieves the same purpose, structure, or function may be substituted for the specific embodiments shown. This application is intended to cover any adaptations or variations of the example embodiments of the invention described herein. It is intended that this invention be limited only by the claims, and the full scope of equivalents thereof.

The Abstract is provided to comply with 37 C.F.R. § 1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

1. A method for market testing radio advertisements, the method comprising:
accessing an advertisement script at an online system;
presenting at least a portion of the advertisement script using an audio recording to a user of the online system to create an advertisement impression;
determining an effectiveness of the advertisement impression; and
reporting the effectiveness of the advertisement impression.

2. The method of claim 1, further comprising:
analyzing the advertisement script to determine a characteristic, wherein the characteristic is selected from the group of characteristics consisting of a type of advertisement, a type of content, a target market, an advertisement structure, and a target advertising platform.

3. The method of claim 1, further comprising:
comparing the effectiveness to a threshold value;
automatically revising the advertisement script when the effectiveness of the advertisement impression is below the threshold value; and
presenting at least a portion of the revised advertisement script to a user of the online system.

4. The method of claim 3, wherein automatically revising the advertisement script includes using a neural network.

5. The method of claim 3, wherein automatically revising the advertisement script includes using discrete analysis.

6. The method of claim 1, further comprising:
comparing the effectiveness to a threshold value;
automatically revising an audio characteristic when the effectiveness of the advertisement impression is below the threshold value; and
presenting the revised audio characteristic to a user of the online system.

7. The method of claim 6, wherein automatically revising the audio characteristic includes using a neural network.

8. The method of claim 6, wherein automatically revising the audio characteristic includes using discrete analysis.

9. The method of claim 6, wherein the audio characteristic is selected from the group of audio characteristics consisting of a gender of a speaker, a language of a speaker, an accent of a speaker, an age of a speaker, an identity of a speaker, a background audio track, a theme, an environmental noise, and a music track.

10. The method of claim 1, wherein presenting at least a portion of the advertisement script comprises using a simulated voice.

11. The method of claim 10, further comprising:
accessing a database comprising a plurality of voice recordings;
constructing a voice track using at least one of the plurality of voice recordings; and
including the voice track in the audio recording.

12. The method of claim 11, wherein accessing the database comprising the plurality of voice recordings comprises:
selecting a voice sample of a speaker using at least one characteristic, wherein the characteristic is selected from the group of characteristics consisting of a gender of the speaker, a language of the speaker, an accent of the speaker, an age of the speaker, and an identity of the speaker.

13. The method of claim 1, further comprising:
comparing the effectiveness to a threshold value; and
delivering the advertisement script to a broadcast station when the effectiveness of the advertisement impression is above the threshold value.

14. A system comprising:
a first module configured to access an advertisement script at an online system;
a second module configured to present at least a portion of the advertisement script using an audio recording to a user of the online system to create an advertisement impression;
a third module configured to determine an effectiveness of the advertisement impression; and
a fourth module configured to report the effectiveness of the advertisement impression.

15. The system of claim 14, further comprising:
a fifth module configured to analyze the advertisement script to determine a characteristic, wherein the characteristic is selected from the group of characteristics consisting of a type of advertisement, a type of content, a target market, an advertisement structure, and a target advertising platform.

16. The system of claim 14, further comprising:
a sixth module configured to compare the effectiveness to a threshold value;
a seventh module configured to automatically revise the advertisement script when the effectiveness of the advertisement impression is below the threshold value; and
an eighth module configured to present at least a portion of the revised advertisement script to a user of the online system.

17. The system of claim 14, further comprising:
a ninth module configured to compare the effectiveness to a threshold value;
a tenth module configured to automatically revise an audio characteristic when the effectiveness of the advertisement impression is below the threshold value; and
an eleventh module configured to present the revised audio characteristic to a user of the online system.

18. The system of claim 17, further comprising:
a twelfth module configured to access a database comprising a plurality of voice recordings;
a thirteenth module configured to construct a voice track using at least one of the plurality of voice recordings; and
a fourteenth module configured to include the voice track in the audio recording.

19. The system of claim 18, further comprising:
a fifteenth module configured to compare the effectiveness to a threshold value; and
a sixteenth module configured to deliver the advertisement script to a broadcast station when the effectiveness of the advertisement impression is above the threshold value.

20. A computer-readable medium including instructions that, when performed by a computer, cause the computer to:
access an advertisement script at an online system;
present at least a portion of the advertisement script using an audio recording to a user of the online system to create an advertisement impression;
determine an effectiveness of the advertisement impression; and
report the effectiveness of the advertisement impression.

21. The computer-readable medium of claim 20, further comprising instructions that cause the computer to:
analyze the advertisement script to determine a characteristic, wherein the characteristic is selected from the group of characteristics consisting of a type of advertisement, a type of content, a target market, an advertisement structure, and a target advertising platform.

22. The computer-readable medium of claim 20, further comprising instructions that cause the computer to:
compare the effectiveness to a threshold value;
automatically revise the advertisement script when the effectiveness of the advertisement impression is below the threshold value; and
present at least a portion of the revised advertisement script to a user of the online system.

23. The computer-readable medium of claim 20, further comprising instructions that cause the computer to:
compare the effectiveness to a threshold value;
automatically revise an audio characteristic when the effectiveness of the advertisement impression is below the threshold value; and
present the revised audio characteristic to a user of the online system.

24. The computer-readable medium of claim 23, further comprising instructions that cause the computer to:
access a database comprising a plurality of voice recordings;
construct a voice track using at least one of the plurality of voice recordings; and
include the voice track in the audio recording.

25. The computer-readable medium of claim 24, further comprising instructions that cause the computer to:
compare the effectiveness to a threshold value; and
deliver the advertisement script to a broadcast station when the effectiveness of the advertisement impression is above the threshold value.
